(19) United States
(12) Patent Application Publication
(10) Pub. No.: US 2025/0318996 A1
(43) Pub. Date: Oct. 16, 2025

(54) DISPENSER

(71) Applicant: Hakan Fredrik BORGQUIST, Abu Dhabi (AE)

(72) Inventor: Hakan Fredrik BORGQUIST, Abu Dhabi (AE)

(21) Appl. No.: 18/865,502

(22) PCT Filed: Jun. 7, 2023
(86) PCT No.: PCT/EP2023/065187

§ 371 Date: Nov. 13, 2024

(30) Foreign Application Priority Data
Jun. 9, 2022 (GB) 2208471.9
Aug. 31, 2022 (GB) 2212579.3

(51) Int. Cl. A61J 7/00

(52) U.S. Cl. CPC A61J 7/0084; A61J 2200/30; A61J 2200/70

(57) ABSTRACT

In a dispenser for dispensing discrete medicaments, a discrete medicament to be taken is contained in a dispensing part (6) of the dispenser. An optical sensor (100, 200) senses the removal of a medicament from the dispensing part, and a transducer (102) produces a signal indicating the removal. The sensor comprises a laser or infrared emitting component (100, 200) and a light-sensitive component (102), and is arranged to detect the interruption or reflection of a beam, by the finger of a user removing the medicament.

### BACKGROUND TO THE INVENTION

This invention relates to a dispenser for dispensing medicaments in the form of tablets, capsules, caplets or the like (hereinafter called “discrete medicaments”).

In one example, the invention is applicable to a dispenser comprising at least one substantially circular holder providing a plurality of compartments for discrete medicaments, the compartments being arranged in a ring, the holder being mounted for rotation in a generally circular recess of a container, the recess having an outlet, and a drive for rotating the holder with respect to the container through a predetermined angle, such that following the rotation, a given compartment is located above the outlet so that a discrete medicament can be dispensed through the outlet.

There are known arrangements, including WO 2021/020976, US 2020/0085694 A1, DE 19852602, US 2016/000657 A1 and WO 2013/120029, in which an infrared or laser beam is used to detect the presence of a medicament in a package or dispenser, before it is removed. Alternatively, a beam can be temporarily interrupted by a medicament as it is dispensed-see WO 90/05684 and WO 2016/061462.

Both of these detection systems rely on the beam being positioned at a height that will be interrupted by the medicament. They may not work if the medicament is the wrong size or there is more than one medicament in a part of a container. Also, some medicaments are translucent and may not be detected properly.

### SUMMARY OF THE INVENTION

It is an aim of the present invention to provide more reliable automatic monitoring of the removal of a discrete medicament from a dispenser.

Accordingly, the invention provides a dispenser for dispensing discrete medicaments, in which a discrete medicament to be taken is contained in a dispensing part of the dispenser, the dispenser including an optical sensor for sensing the removal of a medicament from the dispensing part, and a transducer for producing a signal indicating the removal, the sensor comprising a laser or infrared emitting component and a light-sensitive component, and the sensor being arranged to detect the interruption or reflection of a beam, by the finger of a user removing the medicament.

The dispenser may comprise at least one substantially circular holder providing a plurality of compartments for discrete medicaments, the compartments being arranged in a ring, the holder being mounted for rotation in a generally circular recess of a container, the recess having an outlet providing the dispensing part, and a drive for rotating the holder with respect to the container through a predetermined angle, such that following the rotation, a given compartment is located above the outlet so that a discrete medicament can be dispensed into the dispensing part.

Embodiments of the invention include two such substantially circular holders arranged mutually concentrically, the holders being separately controllable to dispense respective medicaments.

From another aspect, the invention provides a dispenser for dispensing discrete medicaments, the dispenser comprising two substantially circular holders arranged mutually concentrically, the holders being separately controllable to dispense respective medicaments, each holder providing a plurality of compartments for discrete medicaments, the compartments of each holder being arranged in a ring, each holder being mounted for rotation in a generally circular recess of a container, the recess having an outlet, and drives for rotating the holders with respect to the container through a predetermined angle, such that following the rotation, a given compartment is located above the outlet so that a discrete medicament can be dispensed through the outlet.

The dispenser may include a system for monitoring the angle through which the at least one holder has rotated. In a particular embodiment, a plurality of regions that reflect light—e.g. white regions—may be carried either by the at least one holder or by the container, and an optical sensor on the other of the at least one holder or the container may be arranged detect the presence of one of the reflective regions at a given angular position.

The dispenser may have an indicator for indicating when a medicament has been dispensed into the outlet and/or an indicator for indicating when a medicament has been removed.

The dispenser may be arranged to for wireless communication to control and/or monitor the rotation of the at least one holder, and/or monitor the removal of medicaments.

The invention also provides a system comprising a dispenser as described in the immediately preceding paragraph, and an app for wirelessly controlling and/or monitoring the dispensing of medicaments by, and/or removal of medicaments from, the dispenser.

### BRIEF DESCRIPTION OF THE DRAWINGS

Embodiments of the invention will now be described in more detail, by way of example only, with reference to the accompanying drawings, in which:

FIG. 1 is a schematic plan view of a dispenser including a laser sensor;

FIG. 2 is a perspective view of the dispenser of FIG. 1;

FIG. 3 is a perspective view of a dispenser including an infrared sensor;

FIG. 4 is a plan view of the base of the dispenser of FIG. 3;

FIG. 5 shows another dispenser to which the invention is applicable;

FIG. 6 is a view from below of the inner holder of the dispenser of FIG. 5;

FIG. 7 is a view from below of the outer holder of the dispenser of FIG. 5 (10);

FIG. 8 shows the holders of FIGS. 6 and 7, also showing cogs for rotating the holders;

FIG. 9 shows motors and optical sensors of the dispenser;

FIG. 10 is a fragmentary view showing the optical sensors;

FIG. 11 is a cross-sectional view showing how the holders are held in place; and

FIGS. 12, 13 and 14 are screenshots showing an app according to the invention.

### DETAILED DESCRIPTION OF PARTICULAR EMBODIMENTS

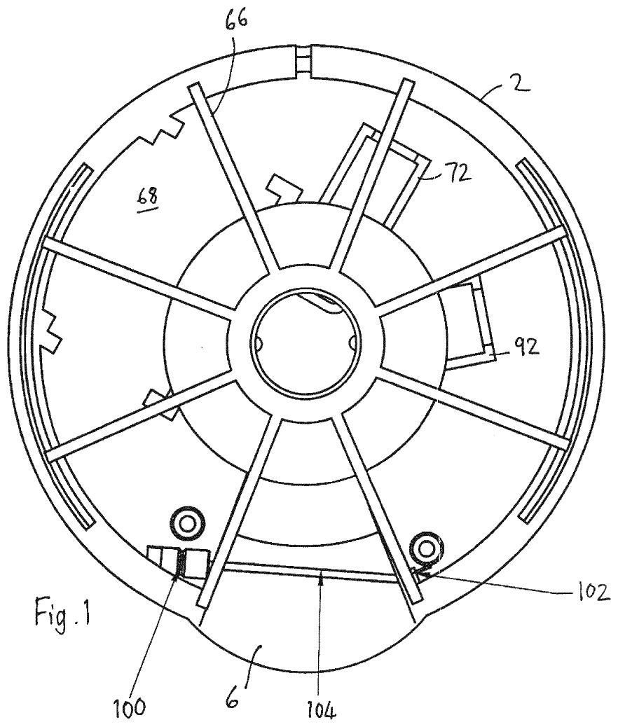

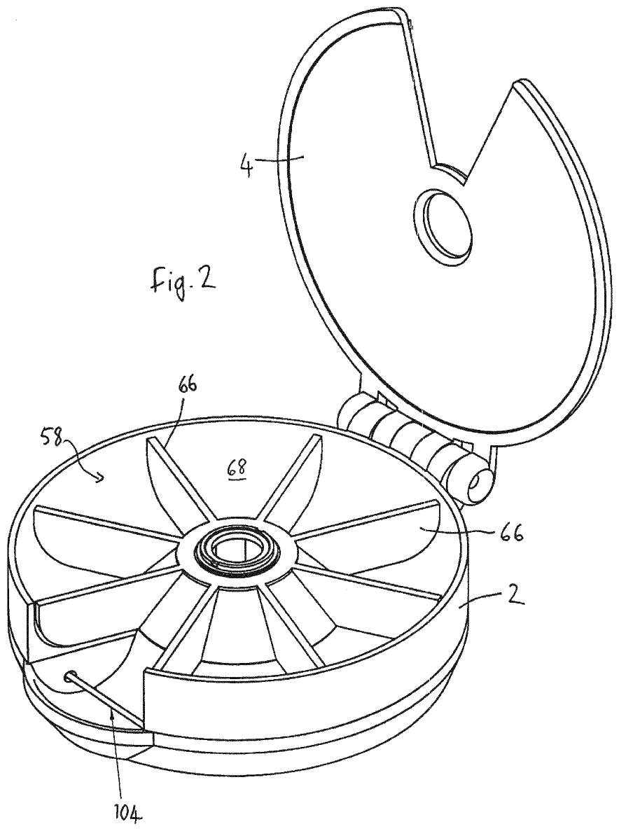

As shown in FIGS. 1-4, dispensers according to the invention comprise a generally circular, hollow base 2 and a generally circular lid 4 hinged to the base 2.

A dish-shaped outlet 6 interrupts the wall of the base 2 at a defined angular position.

A generally circular holder 58 for discrete medicaments is located within the base 2. The motor has radial dividers 66 which define compartments 68.

A motor 72, which may conveniently be a stepper motor drives a cog, which engages teeth of the holder 8 to rotate the holder.

Discrete medicaments are placed in the compartments 58 and the motor 72 is caused to rotate the inner holder until an indicator on the holder is detected by an infrared detector 92, at which point rotation stops. At this point, a loaded compartment 58 aligns with the outlet 6, and a medicament is dispensed into the outlet.

The dispenser is provided with a wireless communication facility, for example by WiFi® or Bluetooth®, to communicate with an app installed on a device operated by a patient or carer.

As shown in FIG. 1, a laser 100 is arranged on one side of the outlet 6 and a photoresistor 102 is arranged on the other side thereof. The photoresistor provides a signal indicating the continuity of a laser beam 104 emitted by the laser 100. When a medicament is removed from the outlet 6, the user's finger interrupts the laser beam 104. The signal from the photoresistor 102 is changed. The dispenser can at this time send a signal to the device indicating that the medicament has been removed.

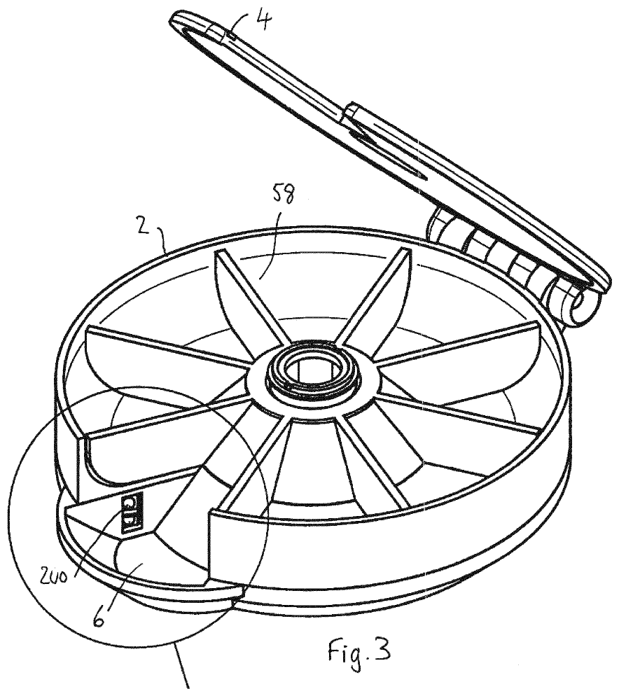

FIGS. 3 and 4 show an infrared sensor 200 facing the outlet 6. This can emit and receive infrared light. A voltage signal produced by the sensor will change when a user's finger reflects the infrared light. Thus, removal of a medicament is detected. Sensitivity can be increased be providing two infrared sensors, one on each side of the outlet 6.

The invention is also applicable to dispensers include two such substantially circular holders arranged mutually concentrically, the holders being separately controllable to dispense respective medicaments.

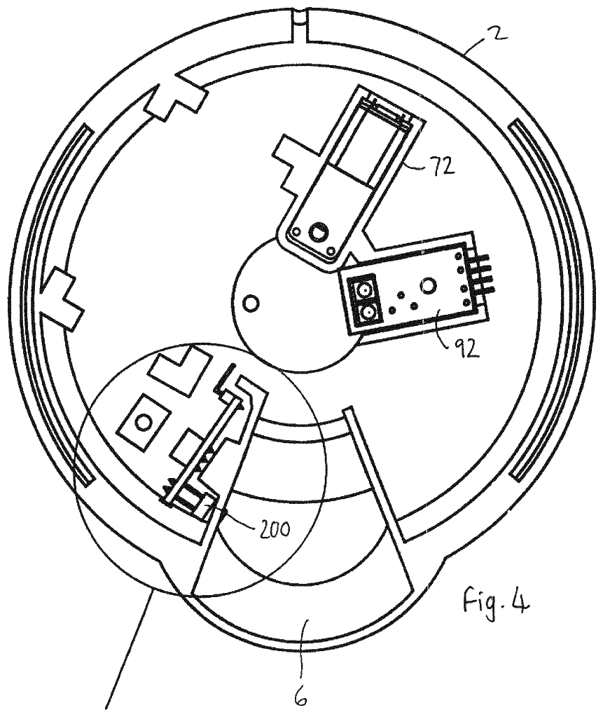

As shown in FIG. 5, an inner holder 8 and an outer holder 10 are located concentrically within the base 2, with the inner holder 8 inside the outer holder 10.

The inner holder 8 is circular in shape and has a hub 12. As shown in FIG. 11, the inner holder 8 is held in place in the base by a retainer 14 which engages the hub 12, whilst allowing the inner holder to rotate. The inner holder 8 has eight radial dividers 16 which define eight inner compartments 18.

The outer holder 10 is generally circular in shape. As shown in FIG. 11, the outer holder is retained by a lip 20 of the inner holder 8 which retains an inner wall 22 of the outer holder 10, whilst allowing the outer holder 10 to rotate relative to both the base 2 and the inner holder 8. The outer holder 10 has eight radial dividers 24 which define eight inner compartments 26.

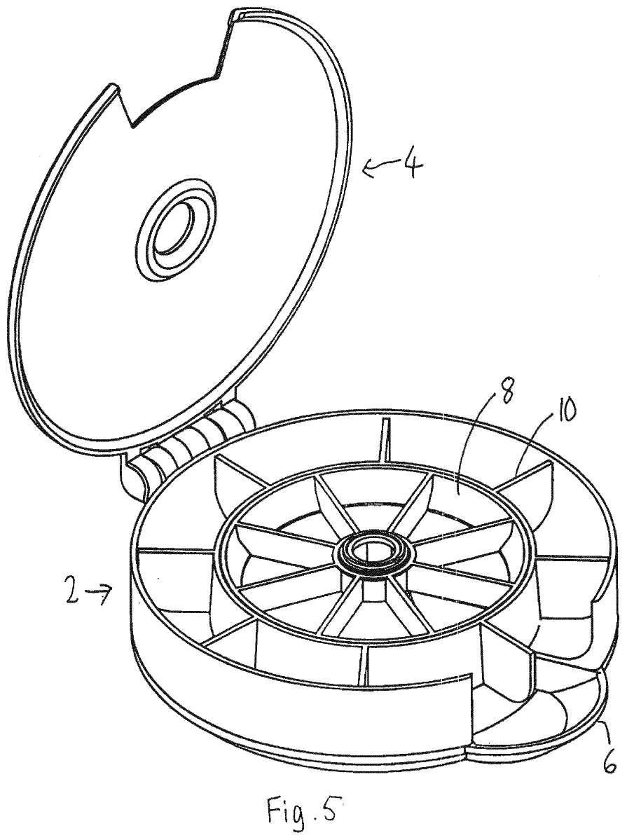

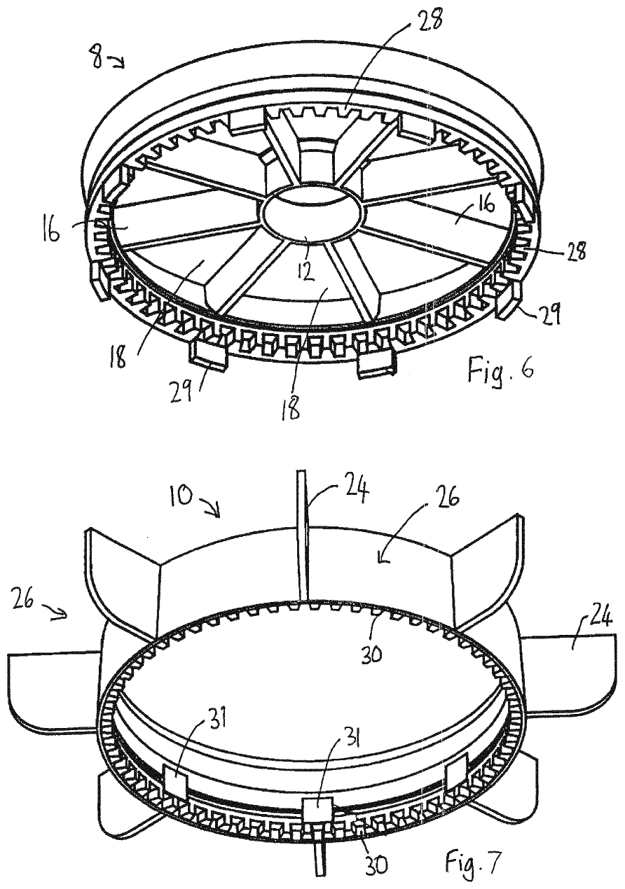

FIG. 6 shows how the inner holder 8 has inwardly-facing teeth 28. It also has eight indicators 29, depending from the wall of the holder, which have white inwardly-facing surfaces.

FIG. 7 shows how the outer holder 10 has inwardly-facing teeth 30. It also has eight indicators 31, on the inner wall of the holder, which have white inwardly-facing surfaces.

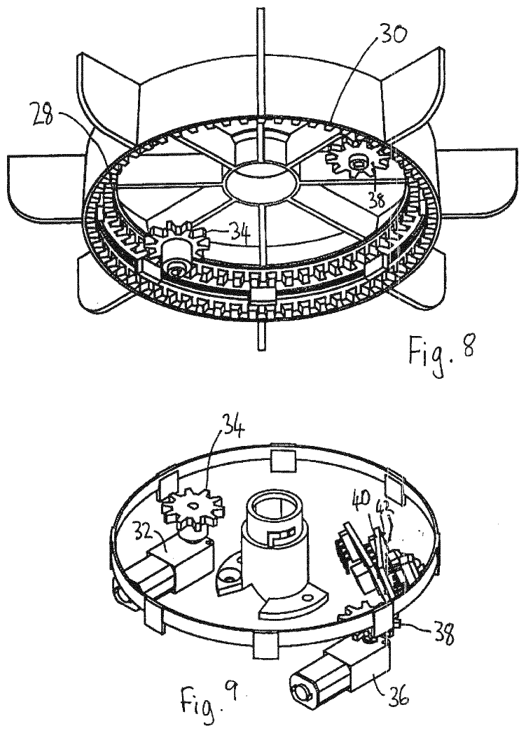

FIG. 9 shows a first motor 32, which may conveniently be a stepper motor, and a cog 34 driven by the first motor, which cog engages the teeth 28 of the inner holder 8 to rotate the inner holder, as shown in FIG. 8. A second motor 36, which may also conveniently be a stepper motor, drives a cog 38, which cog engages the teeth 30 of the outer holder 10 to rotate the outer holder, also as shown in FIG. 4.

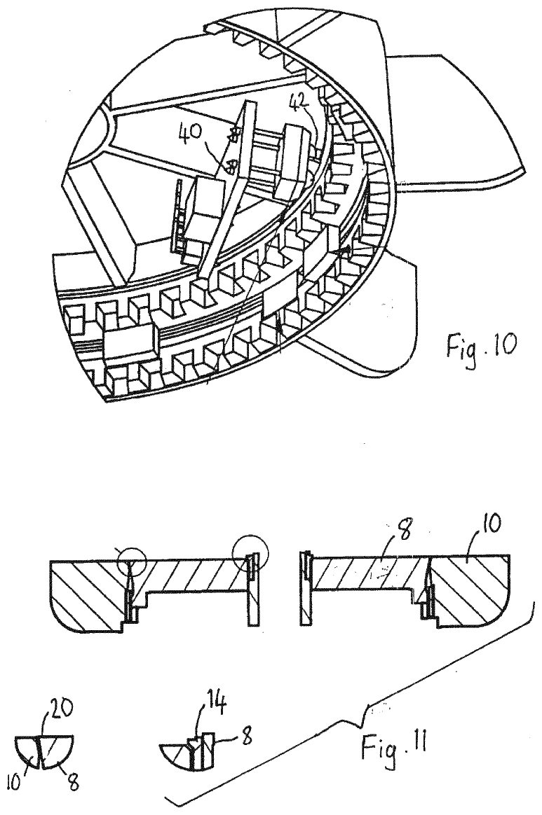

FIGS. 9 and 10 show a circuit board 40 having an infrared detector 42, located at the level of the indicators 29, 31 of the inner holder 8, and the outer holder 10 respectively. When one of the indicators 29, 31 reaches the infrared detector 42, a signal is produced.

Discrete medicaments are placed in the compartments 18 of the inner holder 8, and the first motor 32 is caused to rotate the inner holder until an indicator 29 is detected by the first infrared detector 42, at which point rotation stops. At this point, a loaded compartment 18 aligns with the outlet 6, and a medicament is dispensed into the outlet.

Similarly, discrete medicaments are placed in the compartments 26 of the outer holder 10, and the second motor 36 is caused to rotate the outer holder until an indicator 31 is detected by the second infrared detector 44, at which point rotation stops. At this point, a loaded compartment 26 aligns with the outlet 6, and a medicament is dispensed into the outlet.

The dispenser is provided with one or more light emitting diodes (LED, not shown) which are lit when a medicament has been dispensed and/or removed.

The dispenser is provided with a wireless communication facility, for example by WiFi® or Bluetooth®, to communicate with an app installed on a device operated by a patient or carer.

FIG. 12 is a screenshot showing how a schedule for delivery of medicaments from the inner holder is set up. On a subsequent screen, a schedule for delivery of medicaments from the outer holder is set up. The app then controls the dispenser to rotate the holders 8, 10 and dispense medicaments in accordance with the schedules.

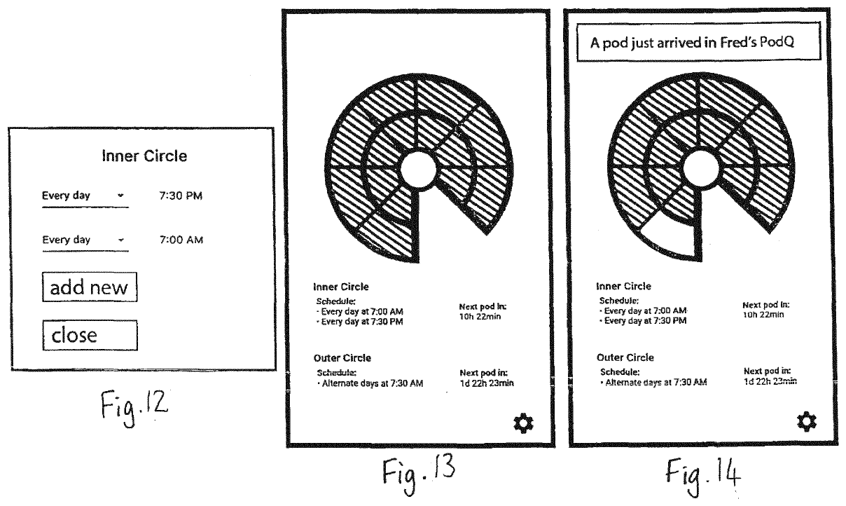

FIG. 13 shows with shading which of the compartments 18, 26 contain a medicament. FIG. 14 shows that one of the compartments is empty as a medicament has been dispensed. At this time, the LED on the dispenser is lit. When the medicament is taken, the LED can be switched off either by pressing a button on the dispenser of via the app.

1. A dispenser for dispensing discrete medicaments, in which a discrete medicament to be taken is contained in a dispensing part of the dispenser, the dispenser including an optical sensor for sensing the removal of a medicament from the dispensing part, and a transducer for producing a signal indicating the removal, the sensor comprising a laser or infrared emitting component and a light-sensitive component, and the sensor being arranged to detect the interruption or reflection of a beam, by the finger of a user removing the medicament.

2. The dispenser according to claim 1, comprising at least one substantially circular holder providing a plurality of compartments for discrete medicaments, the compartments being arranged in a ring, the holder being mounted for rotation in a generally circular recess of a container, the recess having an outlet providing the dispensing part, and a drive for rotating the holder with respect to the container through a predetermined angle, such that following the rotation, a given compartment is located above the outlet so that a discrete medicament can be dispensed into the dispensing part.

3. The dispenser according to claim 2, including two such substantially circular holders arranged mutually concentrically, the holders being separately controllable to dispense respective medicaments.

4. A dispenser for dispensing discrete medicaments, the dispenser comprising two substantially circular holders arranged mutually concentrically, the holders being separately controllable to dispense respective medicaments, each holder providing a plurality of compartments for discrete medicaments, the compartments of each holder being arranged in a ring, each holder being mounted for rotation in a generally circular recess of a container, the recess having an outlet, and drives for rotating the holders with respect to the container through a predetermined angle, such that following the rotation, a given compartment is located above the outlet so that a discrete medicament can be dispensed through the outlet.

5. The dispenser according to claim 2, including a system for monitoring the angle through which the at least one holder has rotated.

6. The dispenser according to claim 5, wherein a plurality of regions that reflect light are carried either by the at least one holder or by the container, and an optical sensor on the other of the at least one holder or the container is arranged to detect the presence of one of the reflective regions at a given angular position.

7. The dispenser according to claim 4, having an indicator for indicating when a medicament has been dispensed into the outlet.

8. The dispenser according to claim 4, having an indicator for indicating when a medicament has been removed.

9. The dispenser according to claim 4, arranged to for wireless communication to control and/or monitor the rotation of the at least one holder, and/or monitor the removal of medicaments.

10. A system comprising a dispenser as according to claim 9, and an app for wirelessly controlling and/or monitoring the dispensing of medicaments by, and/or removal of medicaments from, the dispenser.
